(19) United States
(12) Patent Application Publication
(10) Pub. No.: US 2025/0376038 A1
(43) Pub. Date: Dec. 11, 2025

(54) MECHANICAL FLOAT ASSEMBLY FOR A DYNAMIC ENERGY TRANSFER SYSTEM

(71) Applicant: Caterpillar Inc., Peoria, IL (US)

(72) Inventors: Dennis D. RANKIN, Oro Valley, AZ (US); Steven E. JOHNSON, Metamora, IL (US)

(73) Assignee: Caterpillar Inc., Peoria, IL (US)

(21) Appl. No.: 19/217,755

(22) Filed: May 23, 2025

Related U.S. Application Data
(60) Provisional application No. 63/657,669, filed on Jun. 7, 2024.

(51) Int. Cl. B60L 5/38

(52) U.S. Cl. CPC B60L 5/38

(57) ABSTRACT

A rail connector assembly for an electrically powered mobile machine includes a boom assembly with a first end and a second end, an arm assembly movable between a stowed condition and a deployed condition, the arm assembly having a first end coupled to the boom, and a second end, and a contactor assembly coupled to the second end of the arm assembly. The assembly also includes a hydraulic system controlling movement of the rail connector assembly. The hydraulic system includes a plurality of hydraulic actuators, wherein a first hydraulic actuators of the plurality of hydraulic actuators includes a mechanical float coupling.

### CROSS-REFERENCE TO RELATED APPLICATION

This application claims the benefit of priority to U.S. Provisional Patent Application No. 63/657,669, filed on Jun. 7, 2024, the entirety of which is incorporated herein by reference.

### TECHNICAL FIELD

The present disclosure relates generally to a dynamic energy transfer system for a mobile machine and, more specifically, to a system for controlling a rail connector assembly of a dynamic energy transfer system.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include the ability to safely deliver electricity to a moving industrial vehicle. It is therefore beneficial for industrial machines to have control systems with the ability to quickly deploy or retract a connector assembly, either manually or automatically, with minimal, if any, assistance from the machine operator.

An electric delivery system for providing electric power to a traveling vehicle is described in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. In order to charge the moving vehicle, the delivery system requires a retractable arm to precisely engage with electrical connectors embedded within a horizontal channel of the roadside barriers. While the system described in the '296 publication may be helpful in some circumstances, the '296 publication does not describe, among other things, a system to easily maintain the connection between the electrical delivery system to the roadside electrical conductors while the mobile industrial machines is moving.

Aspects of the present disclosure may solve one or more of the problems set forth above and/or other problems in the art. The scope of the current disclosure, however, is defined by the attached claims, and not by the ability to solve any specific problem.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electrically-powered mobile machine including a rail connector assembly for coupling with a conductive rail system, according to aspects of the present disclosure.

FIG. 2 is a perspective view of an arm assembly and contactor assembly of the rail connector assembly of FIG. 1.

FIG. 3 is a side view of an upper trailing arm assembly actuator including a mechanical float coupling of the arm assembly of FIG. 2.

FIG. 4 is a perspective view of the mechanical float coupling of FIG. 3.

FIG. 5 is an end view of the mechanical float coupling of FIG. 3.

FIGS. 6 and 7 show the mechanical float coupling in various positions during movement of the arm assembly and contactor assembly of FIG. 2.

FIG. 8 is a flowchart illustrating an exemplary method for controlling the rail connector assembly of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

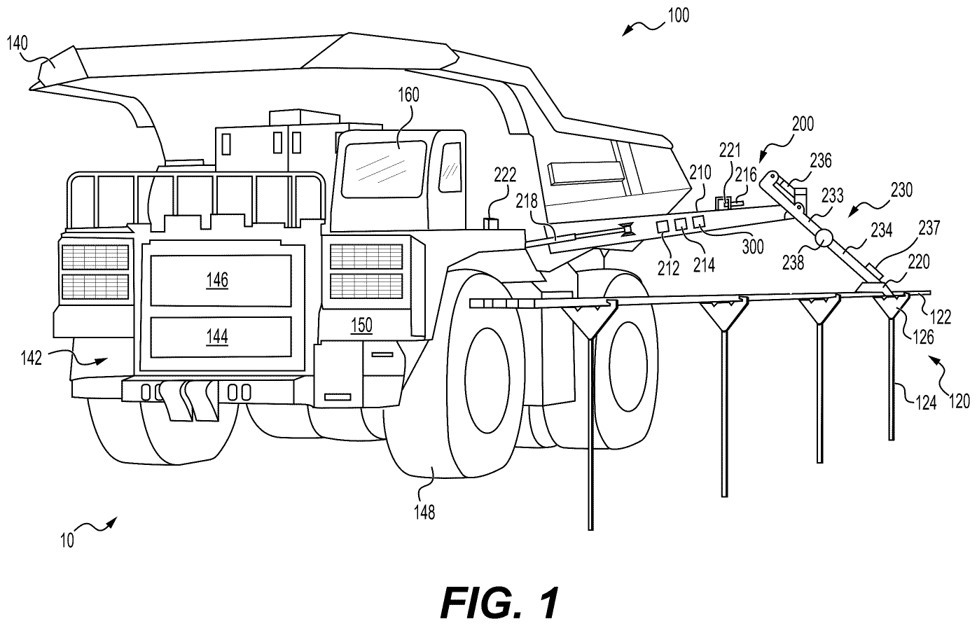

FIG. 1 depicts a mobile machine power system 100 including an electrically-powered mobile machine 140 having an electricity-conducting rail connector assembly 200, and an electricity-conducting rail system 120 for providing electric power to the mobile machine 140. As used herein, the phrase “electrically-powered” includes machine systems that are entirely or all-electric as well as hybrid-electric machine systems. In a hybrid machine, an internal combustion engine is included to assist with propulsion and/or generation of electric power. An internal combustion engine is omitted in an entirely or all-electric machine.

The mobile machine 140 includes an electrically-powered drive system 142 having at least one electric motor 144, and may include at least one battery system 146. The electric drive system 142 drives a set of ground-engaging elements 148, such as tires or continuous tracks, for propelling and maneuvering the mobile machine 140 over the ground 10. The mobile machine 140 also includes a frame/body 150 that supports the mobile machine's mechanical components, including the electricity-conducting rail connector assembly 200. As noted above, mobile machine 140 may include either a hybrid or an all-electric power system, and the electricity-conducting rail system 120 may be applied to either system. Mobile machine 140 and its various systems may be controlled via a machine operator located in the operator cabin 160, and/or mobile machine 140 may be semi- or fully-autonomous or remotely operated.

The mobile machine 140 is free-steering, allowing the operator of the machine (or autonomous control system) to freely control the direction and route of the machine. Thus, the exemplary mobile machine 140 is configured to travel (e.g., in a free-steering manner) selectively along a work route or path within a job site, with the electricity-conducting rail system 120 positioned generally along the route or path. The mobile machine 140 of FIG. 1 is shown in the context of a mining truck which is commonly used for transporting ore in a mine environment. The present disclosure is not so limited, however, and other types of machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, and/or energy storage devices, not shown). The conductor rails 122 may be supported by a plurality of ground-engaging support poles 124 and rail bracket assemblies 126. While FIG. 1 shows an example where the plurality of conductor rails 122 contains three conductor rails, the plurality of conductor rails 122 may contain fewer or more rails. In this example, two of the conductor rails provide electrical power at different polarities (e.g., a conductor rail with a positive polarity and a conductor rail with a negative polarity) while the third conductor rail provides a reference of 0 volts (ground). The elevated conductor rails 122 may have a height, for example, in the range of 8 to 15 feet above the ground 10. Thus, the electricity-conducting rail system does not form a pantograph-type overhead power system, nor an under-machine or low-ground-located power system.

The electricity-conducting rail connector assembly 200 electrically connects the mobile machine 140 to the electricity-conducting rail system 120. The electricity-conducting rail connector assembly 200 includes a boom assembly 210 having a proximal end and a distal end; an arm assembly 230, such as a trailing arm assembly, having a first or proximal end connected to the distal end of the boom assembly 210; and a contactor assembly 220 connected to a second or distal end of the arm assembly 230. As used herein, the term “trailing” refers to a direction opposite the forward direction of travel of the mobile machine 140. The contactor assembly 220 is configured to interface with the electricity-conducting rail system 120 through a plurality of conductor terminals.

The rail connector assembly 200 houses, for example, an electricity-conveying system 212, an electronics system 214, and a hydraulic system 300. Electricity-conveying system 212 may include, for example, various busbars, electrical cables, electrical joints, contactors, brushes, etc. Electronics system 214 may include, for example, an electronic control module (“ECM”), a plurality of sensors, a plurality of electronic actuators, etc. Hydraulic system 300 may include a hydraulic circuit including a hydraulic power unit, hydraulic lines, linear and/or rotary hydraulic actuators, etc., which will be described in more detail below. While electricity-conveying system 212, electronics system 214, and hydraulic system 300 are disclosed as being self-contained on or within rail connector assembly 200 to assist in adding rail connector assembly 200 to existing machine designs, it is understood that various components of these systems could be located on the frame/body 150 of the mobile machine 140. Such frame-located components could include, for example, the hydraulic power unit.

Hydraulic system 300 may be configured for pivotably extending, retracting, and locking the boom assembly 210, arm assembly 230, and connector assembly 220. The ECM may be housed within the boom assembly 210 and receive signals from the mobile machine 140 and the sensors within the rail connector assembly 200 to generate commands to the various components of the rail connector assembly 200. For example, in the case of controlling the hydraulic system 300, the ECM may monitor various components and generate and send actuation commands (e.g., electronic signals) to the various components of the hydraulic system 300. In some embodiments, the rail connector assembly 200 may additionally or alternatively include a pneumatic system for generating and controlling one or more pneumatic actuators for controlling aspects of rail connector assembly 200. While the disclosure below will provide details of hydraulic system 300, it is understood that all or certain components and features may be controlled by a pneumatic system. As used herein, the phrase fluid system or fluid actuator is generic for either a hydraulic or pneumatic system or actuator.

As shown in FIG. 1 the boom assembly 210 extends generally horizontally from a side of the mobile machine and is connected to a side of the frame/body 150 of the mobile machine 140 about a pivot joint. The pivot joint is located at a height of over 8 feet on the machine (above the ground 10). While the boom assembly 210 is shown attached to a large mining truck, the same boom assembly 210 is capable of being incorporated onto various types of mobile machines 140 by use of an interchangeable adapter (not shown) that is specific to the type of machine being operated.

As previously referenced, the electricity-conducting rail connector assembly 200 includes several different states of deployment, including an extended or deployed state in which the boom assembly 210 is extended generally horizontally outward away from a side of the mobile machine 140 (as shown in FIG. 1), a retracted or stowed state (not shown) in which the boom assembly 210 is rotated or pivoted inward to rest against the frame/body 150 of the mobile machine, and a locked state in which the boom assembly is locked to the side of the machine frame/body 150 in the retracted or stowed state. Movement of the rail connector assembly 200 may be achieved by a plurality of actuators, such as, for example a boom actuator 218, a lock actuator 216, an upper trailing arm actuator 236, a middle trailing arm actuator 238, and a lower trailing arm actuator 237. All of these actuators may be part of hydraulic system 300, as will be explained in more detail below. Boom actuator 218 may include a hydraulic actuator, such as a liner hydraulic actuator, coupled between the frame/body 150 of mobile machine 140, and a location along a length of boom assembly 210. Lock actuator 216 may include a linear actuator located, for example, on a top surface of the boom assembly 210. The lock actuator 216 may be actuated to move a locking pin 221 into and out of locking engagement with a lock receiver 222 located on the frame/body 150.

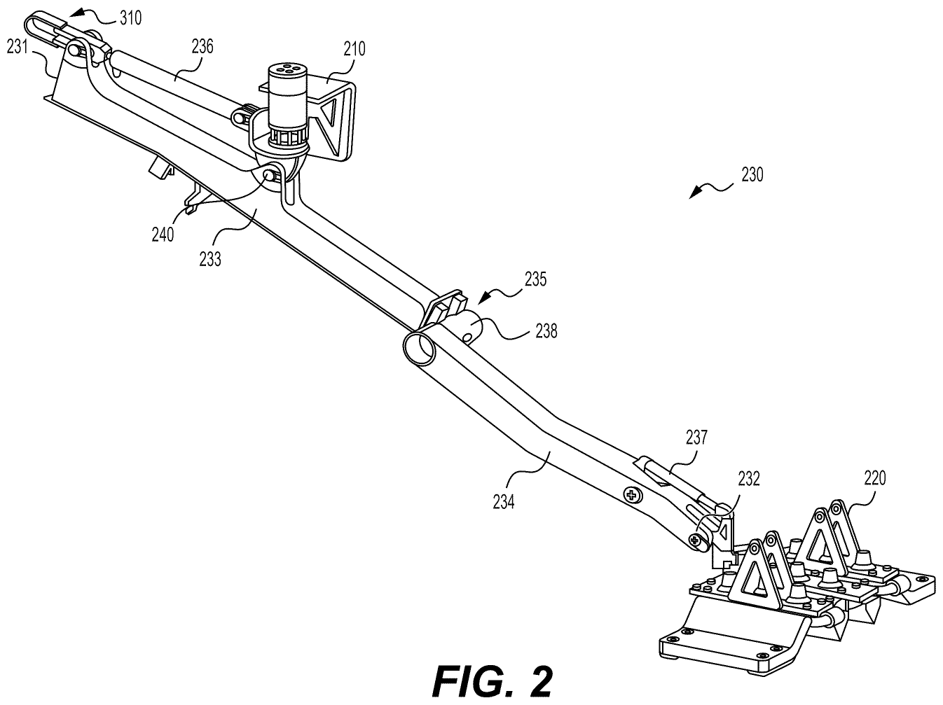

Referring to FIG. 2, the arm assembly 230 of rail connector assembly 200 forms a mechanical and electrical connection between the boom assembly 210 and contactor assembly 220, and may include a first or proximal end 231 connected to an end of the boom assembly 210 and a second or distal end 232 connected to the contactor assembly 220. The arm assembly 230 may be extendable and retractable and may have multiple degrees of freedom to allow for vertical and lateral pivoting about the boom assembly 210. In the exemplified embodiment, the arm assembly 230 may include two portions, an upper portion or arm 233 and a lower portion or arm 234, that are pivotally connected by a central joint 235. Also, upper arm 233 may include a pivot 240 where the upper arm 233 connects to boom assembly 210.

As noted above, the arm assembly 230 may include a plurality of hydraulic actuators 236, 237, 238 including one or more linear actuators and/or one or more rotary hydraulic actuators that move and positon the arm assembly 230. For example, the upper trailing arm actuator 236 may be a liner actuator that controls vertical positioning of upper arm 233. Middle trailing arm actuator 238 may be a 180 degree rotary hydraulic actuator that is coupled between upper and lower arms 233 and 234 at central joint 235, and controls movement of the upper arm 233 vertically with respect to lower arm 234 between a collapsed position where the upper and lower arms 233 and 234 are folded against each other, to an extended or deployed position as shown in FIG. 2. Finally, lower trailing arm actuator 237 may include a linear actuator that controls the orientation of the contactor assembly 220, such as adjusting its pitch. As seen in FIG. 2, the upper trailing arm actuator 236 may be located at the first or proximal end 231 of the arm assembly 230 and the lower trailing arm actuator 237 may be located at the second or distal end 232 of the arm assembly 230.

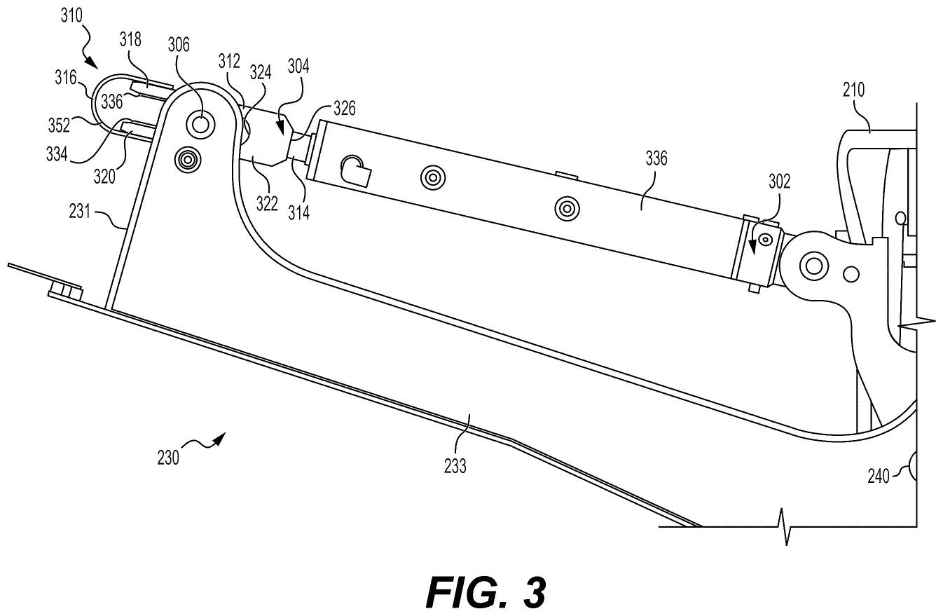

Referring now to FIGS. 3-5, the upper trailing arm actuator 236 includes a head or cap end 302 pivotally connected adjacent the boom pivot 240 of the arm assembly 230. A rod end 304 of the upper trailing arm actuator 236 is pivotably connected to a pin 306 at the proximal end portion 231 of the arm assembly 230. In particular, the rod end 304 of the upper trailing arm actuator 236 includes a mechanical float coupling in the form of a slot coupling 310 that slidingly and pivotingly receives the pin 306 of the trailing arm 236. The slot coupling 310 is arranged to provide vertical float to the arm assembly 230 when the rail connector assembly 200 is in a deployed condition, and in particular, when the contactor assembly 220 is riding along the conductor rails 122 of rail system 120. While the mechanical float coupling is described as associated with the upper trailing arm actuator 236, it is understood that the mechanical float coupling may be additionally or alternatively used on other fluid actuators of the rail connector assembly 200.

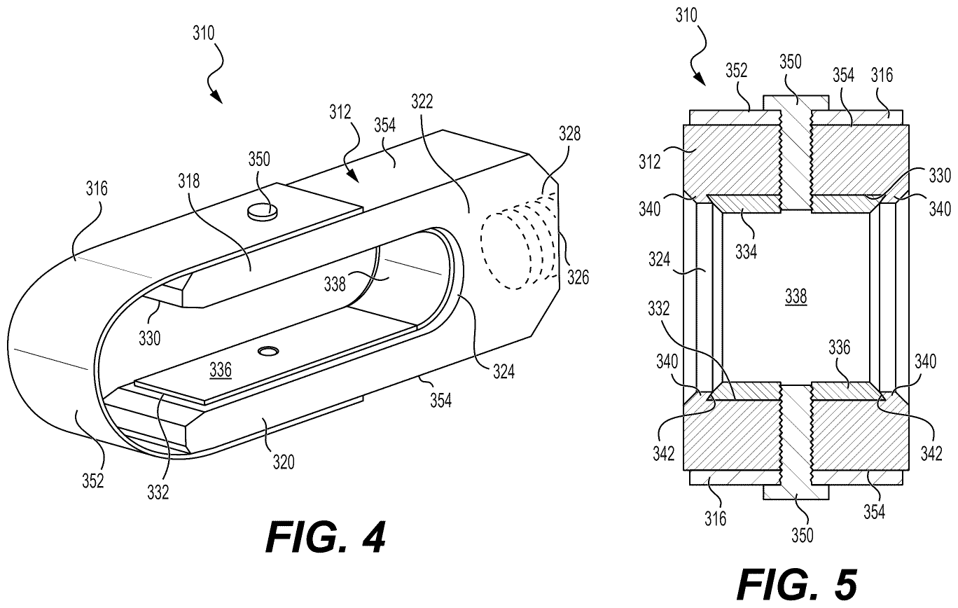

As best shown in FIGS. 3 and 4, the slot coupling 310 includes a U-shaped or fork member 312 fixedly coupled to the rod 314, and a slot closing member 316 fixedly secured to an open end of U-shaped member 312. The U-shaped member 312 may include a top arm member 318 and a bottom arm member 320. The top and bottom arm or leg members 318, 320 are generally straight members and connected by a connection portion 322. The connection portion 322 may include a concave, rounded end 324 and include an opposite end 326 secured to the rod 314 in any appropriate manner, such as a screw connection 328.

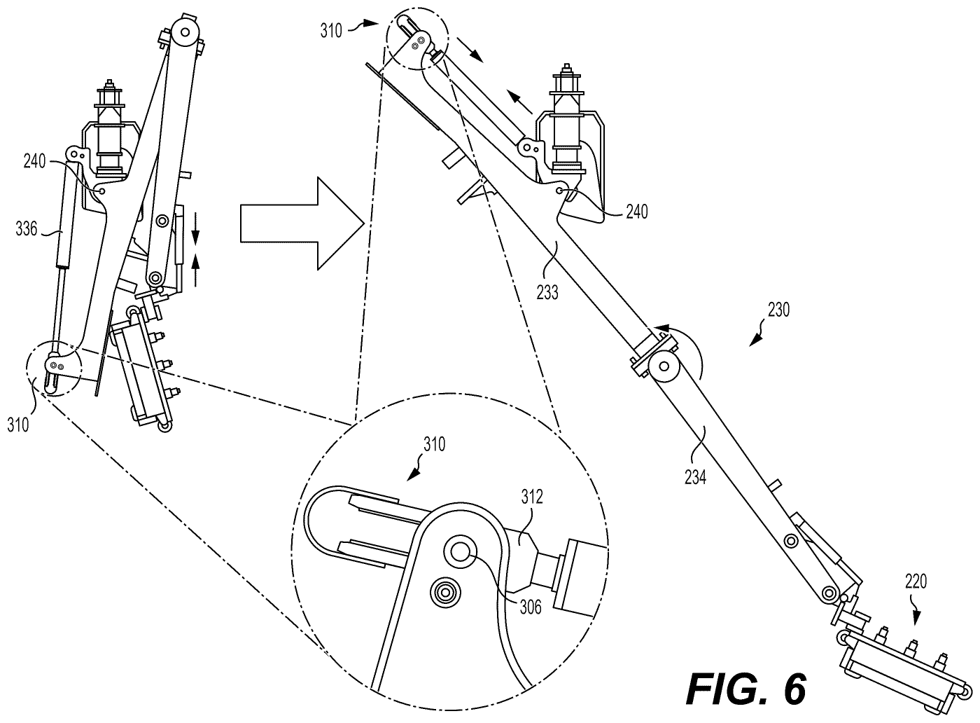

As best shown in FIGS. 4 and 5, top and bottom arm members 318, 320 include opposing planar inner surfaces 330, 332 that may be covered with rectangular wear plates 334, 346. Wear plates 334, 336 may be substantially identical. The rounded end 324 of the connection portion 322 of U-shaped member 312 may similarly be covered, for example by a corresponding C-shaped wear member 338. Wear plates 334, 336, 338 may be received within protruding rail members formed in the U-shaped member 312. For example, as best shown in FIG. 5, top arm member 318 and bottom arm member 320 may each include a pair of opposing protruding rail members 340. These opposing and protruding rail members 340 may including an angled inner surface 342 that corresponds to an angled surface on the edges of wear plates 334, 336. The rounded end 324 may include protruding rail members 344 having generally planar opposing inner surfaces for receiving and mating with planar side edges of the C-shaped wear plate 338.

Wear plates 334 and 336 may be secured to the top and bottom arm member 318, 320 by one or more securing bolts 350 extending from an outer surface of each arm member 318, 320. When secured, the wear plates 334, 336 may each form an abutment against the longitudinal ends of the C-shaped member 338 to secure the C-shaped member 338 against the concave end 324 of the connection portion 322. Additional or alternative methods may be used to secure wear plates 334, 336, 338, such as the additional or alternative use of adhesives. Further, slot closing member 316 may include a flange (not shown) abutting the wear plates 334, 336 to longitudinally secure the wear plates 334, 336 and the C-shaped member 338.

The slot closing member 316 may include a material strip, such as a metal strip 352 forming a C or U shape and wrapped over the open end of the U-shaped member 312, and secured to the outer surfaces 354 of the arm members 318, 320. For example, the securing bolts 350 may extend through the metal strip 352 to fix the metal strip 352 to the top and bottom arm members 318, 320. In an alternative arrangement, slot closing member 316 may be a rod cap type member (not shown) bolted to the open end of the U-shaped member 312. In such an arrangement, the rod-cap-type member may form a continuous or symmetric inner slot surface and may include the above mentioned flange for securing the wear plates 334, 336 in protruding rail members 340.

### INDUSTRIAL APPLICABILITY

The disclosed aspects of the rail connector assembly 200 can be used for deploying and controlling components of rail connector assembly that provides current to a free-steering mobile machine with an electrically-conducting rail system on a worksite.

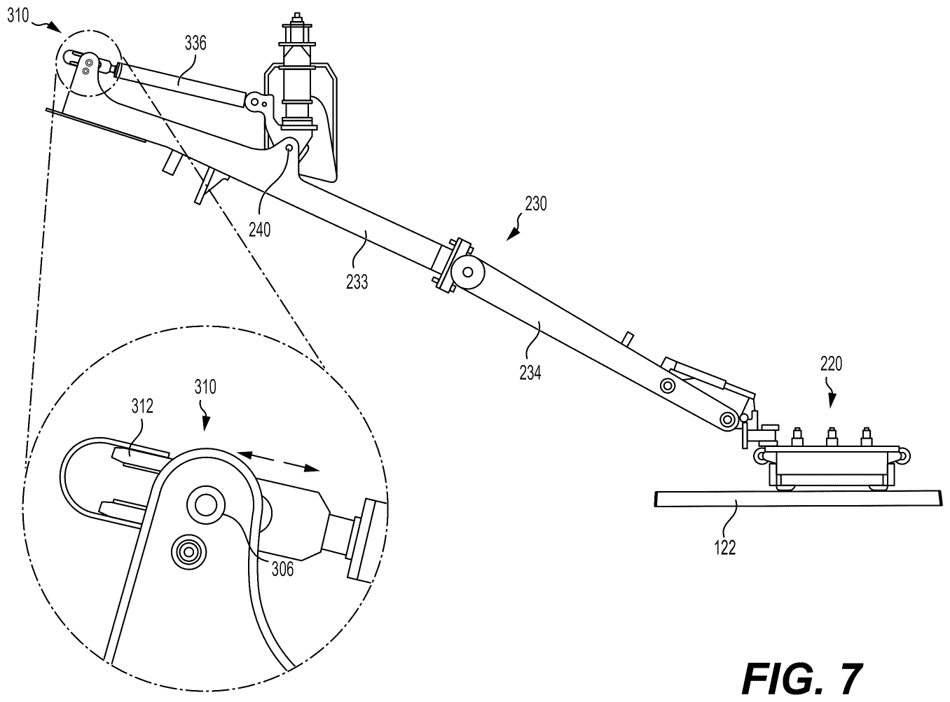

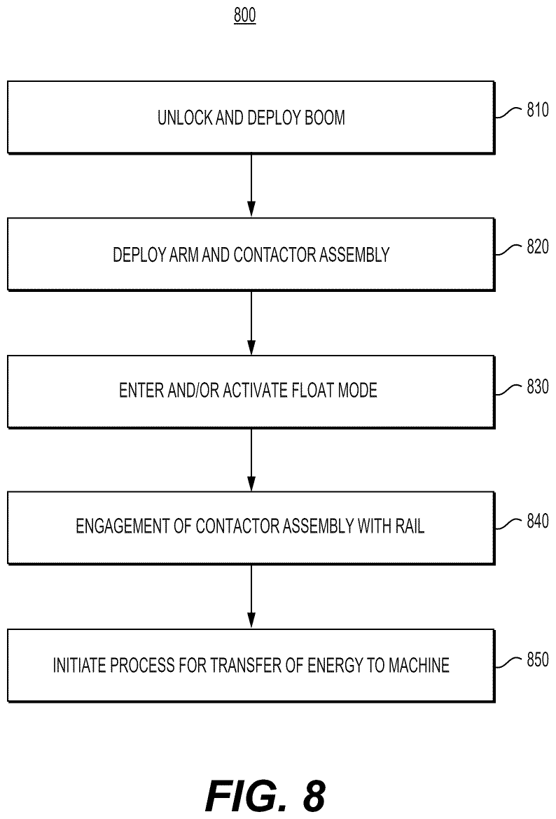

FIG. 6 shows the deployment of the rail connector assembly 200 from the stowed position to the extended or deployed position. FIG. 8 is a flowchart illustrating an exemplary method 800 for operating rail connector assembly 200 of the mobile machine power system 100 according to aspects of the present disclosure. Prior to the performance of method 800, the rail connector assembly 200 may be in a stowed and locked state against a side of the frame/body 150, such that boom assembly 210 extends generally parallel and adjacent the side of the mobile machine 140. Similar to the configuration shown in the left image of FIG. 6, in this stowed and locked state, the arm assembly 230 may be positioned such that upper and lower arms 233 and 234 are folded against one another.

Step 810 may include unlocking and extending or deploying the boom assembly 210 from the stowed position against the mobile machine 140 to an extended or deployed position shown in FIG. 1. For example, the system may receive a request to extend the rail connector assembly 200 to a deployed position that is suitable for engaging with electricity-conducting rail system 120. The request to extend the rail connector assembly 200 may be a single request generated by an operator, for example, pushing a button in the operator cabin 160 or may be automatically generated based on a geographic location of the machine 140 as determined by a Global Navigation Satellite System (“GNSS”). In response to this request, the boom lock actuator 216 may be controlled to retract the locking pin 221 to unlock the boom assembly 210 and the boom actuator 218 may be controlled to extend the boom assembly 210 away from the side of the mobile machine 140. The step 810 of unlocking and deploying boom assembly 210 may also include the actuation of the lower trailing arm actuator 237 to pivot contactor assembly 220 away from upper arm 233 to magnetically decouple the contactor assembly 220 from the upper arm 233. This movement of the contactor assembly is shown in the left image of FIG. 6. Once the boom is in the deployed position (FIG. 1), the boom actuator 218 may be hydraulically locked (the position shown in FIG. 1) to secure the boom assembly 210 in the deployed position.

Concurrently with, or immediately after unlocking and extending the boom assembly 210 to the deployed position in step 810, the arm assembly 230 and contactor assembly 220 may be moved the deployed position shown in the right image of FIG. 6 (step 820). This may include controlling the upper trailing arm actuator 236 to move the actuator piston towards the cap end 302 (as indicated by the arrows in the right side image of FIG. 6). This will cause the proximal end 231 of the arm assembly 230 to raise, and the central joint 235 to lower vertically based on pivot 240. During this movement, the middle arm assembly actuator 238 may be in a hold or lock condition. As shown in FIG. 6, during this movement of the upper trailing arm actuator 236, pin 306 of the upper arm 233 is urged against the rounded end 324 of slot coupling 310 due to the weight of the lower arm 234 and contactor assembly 220. When upper trailing arm actuator 236 has moved the upper arm 233 to the deployed position (FIGS. 1 and 2), upper trailing arm actuator 236 may be at a predefined lower limit. During or after movement of the upper arm 233 to the deployed position, lower trailing arm actuator 237 may be actuated to position the contactor assembly 220 to the deployed position, such as the position shown in FIG. 2. Similar to upper trailing arm actuator 236, lower trailing arm actuator 237 may be at a predefined lower limit in the deployed position shown in FIG. 6. Finally, step 820 may include controlling the middle arm assembly actuator 238 so that the lower arm 234 extends farther away from upper arm 233 and provides the generally linear arrangement shown in FIG. 2. This movement is show by the rotation arrow of FIG. 6.

With the arm assembly 230 in the deployed position as shown in FIG. 6, the arm assembly 230 and contactor assembly 220 may be in position to make contact with the conductor rails 122 of rail system 120, for example an ingress ramp (not shown) of the rail system 120. As noted above, this deployed position of the arm assembly 230 and contactor assembly 220 as depicted in FIG. 6 may correspond to a vertical lower limit of the one or both of the upper trailing arm actuator 236 and lower trailing arm actuator 237. At this point, arm assembly 230 and/or contactor assembly 220 may be in, or be activated to enter, a float mode (step 830). Float mode may correspond to an only-mechanical float of the upper trailing arm assembly 230 and/or the contactor assembly 220 via a mechanical float connector, for example, the slot connector 310. Alternatively, as discussed below, float mode may include both mechanical float and hydraulic float of the arm assembly 230 and/or contactor assembly 220. In the only-mechanical float, undesired vertical movements of the rail connector assembly 200, along with any vertical movement of the rail connector assembly 200 riding on the conductor rails 120 (e.g. along an ingress ramp) may be absorbed by the one or more mechanical float connectors without hydraulic float of the actuators. In this case the movement of the pin 306 in slot connector 310 serves to absorb the vertical movements of the rail connector assembly 200. Thus, the length of the arms 318, 320 of the slot connector 310 may be of a size capable of absorbing the height change of the arm assembly 230 along an ingress and egress ramp of the rail system 120, and any unexpected vertical movements.

Float mode may alternatively also include a hydraulic float including actuation of the hydraulic system 300 so that one or both of the upper trailing arm actuator 236 and the lower trailing arm actuator 237 allow cross flow between the rod end and the cap end of the respective actuator. In this float mode, the arm assembly 230 and contactor assembly 220 may be permitted to move when acted on by external forces, such as the forces associated with the contactor assembly 220 contacting or engaging an ingress ramp of the rail system 120 and, e.g., raising the arm assembly 230 (step 840). Thus, the float mode allows the arm assembly 230 and contactor assembly 230 to properly vertically align for sliding contact along the conductor rails 122, weather on an ingress ramp or along a generally horizontal section of the conductor rails, as shown in FIG. 7. While the above description involves the deployed position of the arm assembly 230 and contactor assembly 220 being in the float mode, it is understood that the deployed position may alternatively correspond to a hydraulically held or locked position of the respective actuators. In this case, the float mode may be actuated upon initial contact of the contactor assembly 220 with the conductor rails 122. Such initial contact may be monitored and sensed condition using any appropriate sensing system, such as by pressure or position sensors associated with one or more of the trailing arm actuators 236, 237, 238, and/or one or more visual or proximity sensors.

The hydraulic float mode may also include the mechanical float provided by slot coupling 310. Referring to FIG. 7, as the arm assembly 230 and contactor assembly 220 slide along, for example a horizontal section of conductor rails 122, vertical undulations or bumps experienced by rail connector assembly 200 based on the mobile machine 140 traversing bumps or undulations and/or vertical discrepancies in the conductive rails 122, may be absorbed by sliding movement of pin 306 within the slot formed between upper and lower arm members 318 and 320 of the slot coupling 310 of the upper trailing arm actuator 236. This mechanical float is shown by the double arrow in FIG. 7. It is noted that the mechanical float provided by the slot coupling 310 may be a passive float, wherein the extension or retraction of the rod end 304 of upper trailing arm actuator 236 is not actively controlled. However, one or more sensors could be used to actively extend or retract the rod end 304 of upper trailing arm actuator 236 to actively position the pin in a longitudinally central portion of the slot coupling 310 to allow the mechanical float to move in generally the same amount in both the vertically up and down directions. Further, while float mode is described above with respect to both hydraulic and mechanical float, as explained above, it is understood that float mode could be limited to only mechanical float.

As noted above, the float mode helps to maintain contactor assembly 220 in contact with the rails 122 of the rail system 120 when the mobile machine 140 experiences vertical undulations or bumps during travel that affects the vertical location of the rail connector assembly 200. The mechanical float may provide for a better reaction time to vertical undulations or bumps of mobile machine 140 than the reaction time associated with a hydraulic float. The two degrees of freedom provided by the float mode allows compensation for both the upper arm 233 and the contactor assembly 220, which can be beneficial when the mobile machine 104 experiences relatively large undulations or bumps. It is understood, however, that the float mode could be limited to float of only one of the upper trailing arm actuator 236 or the lower trailing arm actuator 237. Further, a float mode could include actuating a float valve 310 (not shown) associated with the middle trailing arm actuator 238 to a float position, instead of a float valve 310 associated with the upper trailing arm actuator 236.

Once the contactor assembly 220 is in contact or engagement with the rails 122, and the arm assembly 230 is in float mode, the rail connector assembly 200 can initiate a process for transferring energy from the rails 122 to the mobile machine 140 (step 850). Such a process can include various confirmations or checks before engaging the electrical conductor terminals of the contactor assembly 220 with the rail 122 and conveying current along the rail connector assembly 200 to one or more motors 144 or the battery system 146 of the mobile machine 140.

In accordance with the present disclosure, the hydraulic system 300 associated with the rail connector assembly 200 may provide assistance in maintaining contact between the arm assembly 230 and the rails 122 of the electricity-conducting rail system 120, even when the mobile machine 140 experiences undesired undulations or bumps.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail connector assembly for an electrically powered mobile machine, comprising:
a boom assembly with a first end and a second end;
an arm assembly movable between a stowed condition and a deployed condition, the arm assembly having a first end coupled to the boom, and a second end;
a contactor assembly coupled to the second end of the arm assembly; and
a hydraulic system controlling movement of the rail connector assembly, the hydraulic system including:
a plurality of hydraulic actuators, wherein a first hydraulic actuators of the plurality of hydraulic actuators includes a mechanical float coupling.

2. The rail connector assembly of claim 1, wherein the mechanical float coupling is configured to provide vertical float to the arm assembly.

3. The rail connector assembly of claim 1, wherein the first hydraulic actuator is a linear actuator for moving the arm assembly, and the mechanical float coupling forms an end portion of the first linear actuator.

4. The rail connector assembly of claim 3, wherein the mechanical float coupling is a slot coupling.

5. The rail connector assembly of claim 4, wherein slot coupling includes a U-shaped member having a first arm and a second arm.

6. The rail connector assembly of claim 5, wherein a closing member is coupled to the first and second arms to close an open end of the U-shaped member.

7. The rail connector assembly of claim 6, wherein the closing member is a material strip coupled to an outer surface of the first and second arms.

8. The rail connector assembly of claim 6, wherein the U-shaped member slidingly receives a pin of the arm assembly.

9. The rail connector assembly of claim 8, wherein at last one of the first arm and second arm of the U-shaped member receives a wear member at an interface between the pin and the U-shaped member.

10. The rail connector assembly of claim 9, wherein at least one of the first arm or the second arm receives a coupling member that couples at least a portion of both the closing member and the wear member.

11. The rail connector assembly of claim 2, wherein the float coupling is located at an end portion of the arm assembly.

12. The rail connector assembly of claim 11, wherein the float coupling is a slot coupling forming a rod end of the first hydraulic actuator.

13. A rail connector assembly for an electrically powered mobile machine, comprising:
an arm assembly located at a side of the mobile machine and movable between a stowed condition and a deployed condition, the arm assembly having a first end and a second end;
a contactor assembly coupled to the second end of the arm assembly; and
a fluid system controlling movement of the rail connector assembly, the fluid system including:
a plurality of fluid actuators, wherein a first fluid actuator of the plurality of fluid actuator includes a mechanical float coupling configured to provide vertical float to the arm assembly when the arm assembly is in the deployed condition.

14. The rail connector assembly of claim 13, wherein the first fluid actuator is a linear actuator for moving the arm assembly, and the mechanical float coupling forms an end portion of the first linear actuator.

15. The rail connector assembly of claim 13, wherein the mechanical float coupling is a slot coupling.

16. The rail connector assembly of claim 13, wherein the float coupling is located at an end portion of the arm assembly.

17. The rail connector assembly of claim 13, wherein the slot coupling includes a U-shaped member including a first arm and a second arm.

18. The rail connector assembly of claim 17, wherein a closing member is coupled to the first and second arms to close an open end of the U-shaped member, and the U-shaped member slidingly receives a pin of the arm assembly.

19. A method of operating a rail connector assembly of an electrically powered mobile machine, the rail connector assembly including a boom assembly with a first end and a second end; an arm assembly movable between a stowed condition and a deployed condition, the arm assembly having a first end coupled to the boom, and a second end; a contactor assembly coupled to the second end of the arm assembly, the method including:
moving the boom assembly from a retracted position to deployed position;
moving the arm assembly from a retracted position to a deployed position using a plurality of hydraulic actuators; and
absorbing vertical movement of the mobile machine by at least one of the plurality of hydraulic actuators being in a mechanical float condition using a mechanical float coupling.

20. The method of claim 19, further including placing at least one of the plurality of hydraulic actuator in a hydraulic float condition.
